(19) United States
(12) Patent Application Publication
(10) Pub. No.: US 2006/0116928 A1
(43) Pub. Date: Jun. 1, 2006

(54) Distribution advertisement management system, method, computer-readable recording medium and computer data signal embedded in carrier

(76) Inventor: Akira Onozato, San Mateo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/000,511

(22) Filed: Nov. 29, 2004

(51) Int. Cl. G07G 1/14

(52) U.S. Cl. 705/14

(57) ABSTRACT

A management server receives an input of user information and registers it with a user information database, in response to an access request specifying an address recorded in an advertising medium. The management server further receives an input of an advertisement genre a user desires and registers advertisement genre information specified by the genre with the user information database in association with the user information. The management server extracts the advertisement genre information for advertisement distribution and the user information, further extracts advertisement information specified by the extracted advertisement genre information from an advertisement database, and generates an advertising medium by printing the advertisement information on a medium. The management server, then, processes for transmitting the generated printing medium to an advertisement destination specified by the extracted user information.

### BACKGROUND OF THE INVENTION

This invention relates to a distribution advertisement management system, method, and the like for managing an advertisement to be distributed to users.

Advertising media such as pocket-sized packs of tissue papers have conventionally been distributed to recipients, who are passersby walking on a street, without choice by distributors requested by an advertiser. For this reason, it has been difficult to distribute an appropriate advertisement to appropriate recipients (general consumers).

In addition, since an advertiser distributes pocket-sized packs of tissue papers by requesting distributors when distributing an advertisement, a labor cost has inevitably been taken for each provision of advertisements.

Furthermore, an access to an advertisement, which a recipient actually desires, has been unilateral just by being distributed to passersby walking on a street without choice by distributors, and a function as an advertising medium has not been fulfilled unless a recipient receives an advertisement the recipient actually desires.

A system, for example, for providing advertisement information to subscribers has been disclosed in Unexamined Japanese Patent Publication No. 2003-196533. However, the system is that a subscriber of an advertising medium distributed accesses the prescribed Web page on a computer, searches advertisement data and retrieves them, but is not for distributing an advertising medium such as a pocket-sized pack of tissue papers, in which an advertisement is described, to an appropriate consumer, depending on advertising claims.

### BRIEF SUMMARY OF THE INVENTION

The present invention has been made in view of the above-mentioned points, and therefore an object of the present invention is to provide a distribution advertisement management system, method, and the like for distributing an advertisement appropriately to consumers.

In order to achieve the above object, a distribution advertisement management system in the first view of the present invention has a user information registration part, in which an input of user information is received and registered with a user information database in response to an access request specifying an address described in an advertising medium, an advertisement genre registration part, in which an input of an advertisement genre a user desires is received and registered with said user information database, relating advertisement genre information specifying the genre to said user information, an extraction part, in which advertisement genre information and user information for an advertisement distribution are extracted from said user information database, an advertisement extraction part, in which advertisement information on a genre specified by said extracted advertisement genre information is extracted from an advertisement database, an advertising medium generation part, in which an advertising medium is generated by printing said extracted advertisement information on a medium, and a transmission processing part, in which processing for transmitting said generated advertising medium to a destination of an advertisement specified by said extracted user information is carried out.

A distribution advertisement management method in the second view of the present invention has the steps of: receiving an input of user information and registering it with a user information database in response to an access request specifying an address described in an advertising medium, receiving an input of an advertisement genre a user desires and registering advertisement genre information specifying the genre with said user information database in association with said user information; extracting advertisement genre information and user information for an advertisement distribution from said user information database, extracting advertisement information on a genre specified by said extracted advertisement genre information from an advertisement database, generating an advertising medium by printing said extracted advertisement information on a medium, and transmitting said generated advertising medium to a destination of an advertisement specified by said extracted user information.

A computer-readable recording medium in the third view of the present invention, which stores a program with which a computer executes the steps of: receiving an input of user information and registering it with a user information database in response to an access request specifying an address described in an advertising medium, receiving an input of an advertisement genre a user desires and registering advertisement genre information specifying the genre with said user information database in association with said user information, extracting advertisement genre information and user information for an advertisement distribution from said user information database, extracting advertisement information on a genre specified by said extracted advertisement genre information from an advertisement database, generating an advertising medium by printing said extracted advertisement information on a medium, and transmitting said generated advertising medium to a destination of an advertisement specified by said extracted user information.

A computer data signal embedded in a carrier in the fourth view of the present invention, which represents a program with which a computer executes the steps of: receiving an input of user information and registering it with a user information database in response to an access request specifying an address described in an advertising medium, receiving an input of an advertisement genre a user desires and registering advertisement genre information specifying the genre with said user information database in association with said user information; extracting advertisement genre information and user information for an advertisement distribution from said user information database, extracting advertisement information on a genre specified by said extracted advertisement genre information from an advertisement database, generating an advertising medium by printing said extracted advertisement information on a medium, and transmitting said generated advertising medium to a destination of an advertisement specified by said extracted user information.

### BRIEF DESCRIPTION OF THE DRAWINGS

FIG. 1 is a diagram showing a configuration example of a distribution advertisement management system according to an embodiment of the present invention.

FIG. 2 is a diagram showing a configuration example of a management server.

FIG. 3 is a diagram showing an example of a data structure of user information.

FIG. 4 is a diagram showing an example of an advertisement registration screen.

FIG. 5 is a diagram showing an example of a data structure of advertisement genre information.

FIG. 6 is a diagram showing a configuration example of a printer.

FIG. 7 is a flow chart for explaining information registration processing.

FIG. 8 is a flow chart for explaining advertisement information output processing.

FIG. 9 is a diagram showing another example of an advertisement registration screen.

### DETAILED DESCRIPTION OF THE INVENTION

A distribution advertisement management system according to an embodiment of the present invention will be described in reference to the accompanying drawings.

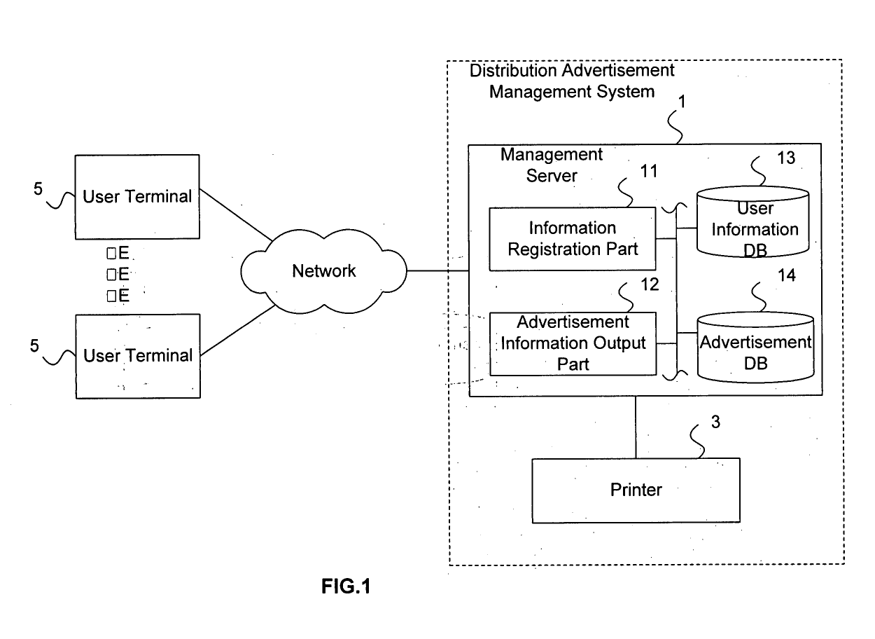

A configuration example of a distribution advertisement management system according to the present embodiment is shown in FIG. 1. As shown in the diagram, the distribution advertisement management system is equipped with a management server 1 and a printer 3, and the management server 1 is connected to user terminals 5 through a network such as Internet.

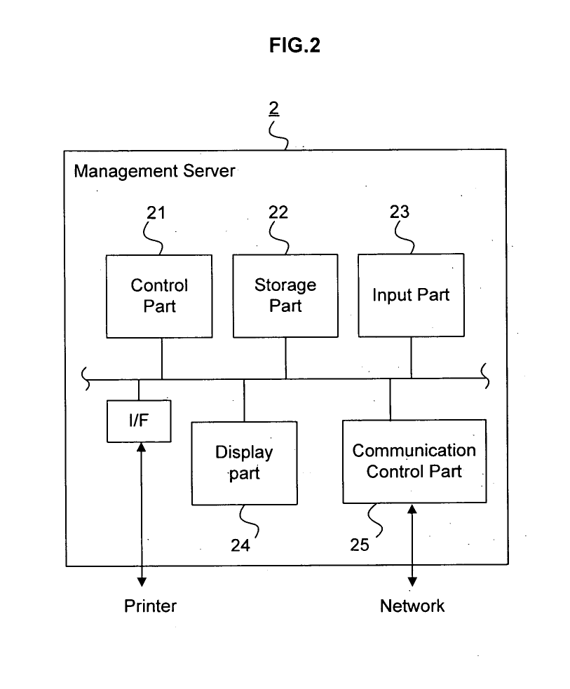

A hardware configuration of the management server 1 is shown in FIG. 2. The management server 1 consists of a computer equipped with, for example, a control part 21, a storage part 22, an input part 23, a display part 24 and a communication control part 25, and is connected to the printer 3.

The control part 21 consists of a CPU or the like and logically realizes an information registration part 11, an advertising medium generation part 12 and a transmission processing part 13.

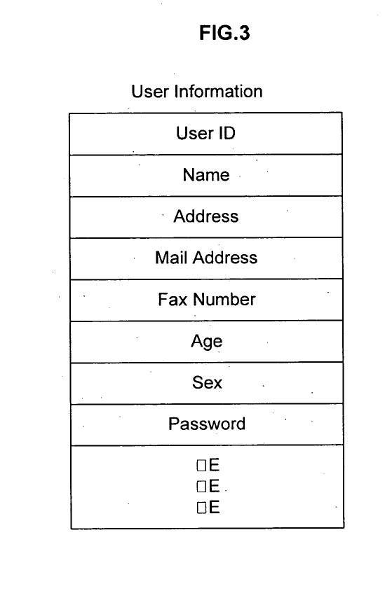

In the information registration part 11, in response to a request specifying an address of a website the management server 1 provides, processing for receiving and registering user information on a user is carried out. In the present embodiment, address information (such as a URL) specifying the website provided by the management server 1 is described in an advertising medium such as a pocket-sized pack of tissue papers. The advertising medium is, then, distributed to a general consumer such as a passerby on a street. It is also described in the advertising medium that a distribution of an advertisement can be received by accessing the website. A general consumer who received the advertising medium accesses the address described in the advertising medium by using the user terminal 5. The information registration part 11 transmits a prescribed Web page (homepage) to the user terminal 5 when received a request specifying the address of the website provided by the management server 1 from the user terminal 5, and then transmits a registration screen, on which an input of personal information such as an arbitrary user ID, user name, address, phone number, mail address, fax number, age and sex can be received, to the user terminal 5 in response to a notification indicating a selection of “User Registration” on the Web page when the selection is carried out. In the information registration part 11, received data is registered as user information with a user information database (DB) 13 in the storage part 22 when the input data for the user registration screen is received. Then, a password is issued for the user information registered and the generated password is registered as a part of the user information while transmitting the password along with a user ID to a mail address included in the user information previously registered. An example of user information to be registered with the user information DB 13 is shown in FIG. 3. Among a lot of the user information, the user name, address, mail address, fax number, and the like become destination information to be employed as a destination of an advertisement distribution.

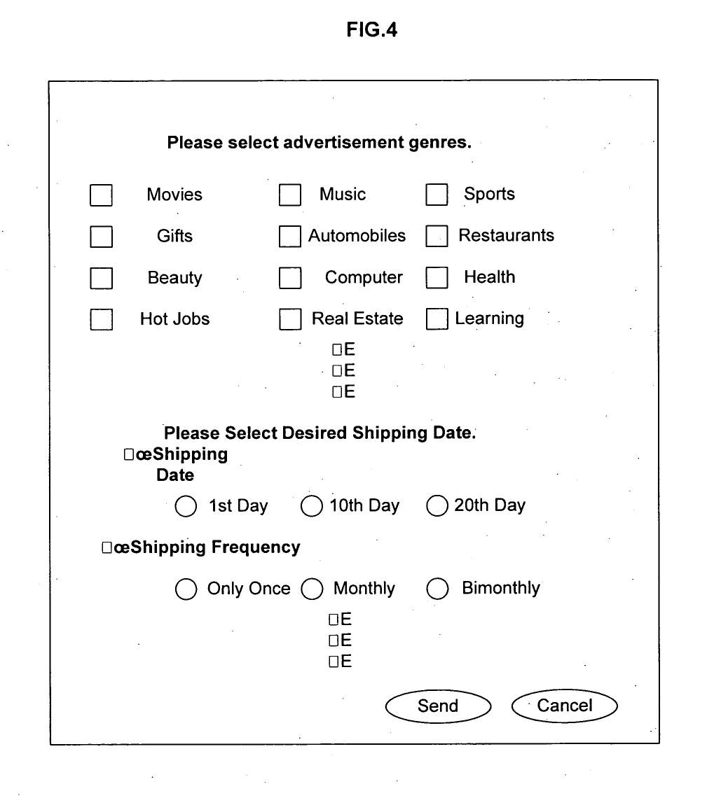

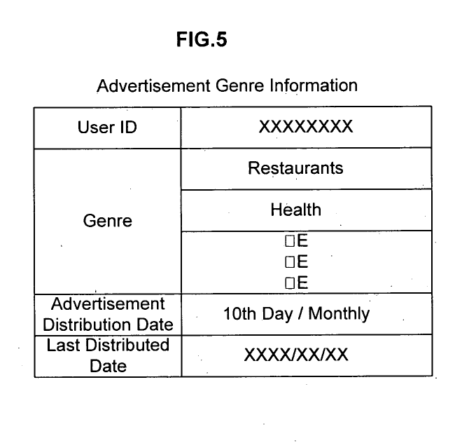

Furthermore, when “Distribution Advertisement Registration” on the Web page is selected, the information registration part 11 transmits an input screen for a user ID and a password to the user terminal 5 and receives an input of them, in response to a notification of the selection. After confirming if the input user ID and password have already been registered with the user DB 13, data of an advertisement registration screen, on which an input of an advertisement genre the user desires to receive (such as movies, music, sports, gifts, automobiles, restaurants, beauty, computer, health, hot jobs, real estate, and learning) and of a desired distribution date (including a distribution frequency) is received, is transmitted to the user terminal 5. The advertisement registration screen can include, for example as shown in FIG. 4, check boxes for selecting what a user desires among plurality of advertisement genres and for selecting a distribution date a user desires. When the information registration part 11 receives input data for the advertisement registration screen (see FIG. 4) from the user terminal 5, it generates advertisement genre information based on the received data and registers it with the user information DB 13. The advertisement genre information includes data such as, as shown in FIG. 5, a user ID, advertisement genre, desired distribution date and last distributed date. The advertisement genre information is associated with the user information by the user ID.

In the advertising medium generation part 12, processing for generating advertising media based on data being registered with the user information DB 13 and advertisement information DB 14 is carried out. In particular, in the advertising medium generation part 12, advertisement genre information to be distributed today and user information associated with it are extracted, based on desired distribution date or the last distributed date specified by advertisement genre information being registered with the user information DB 13 and on today's date acquired from an internal clock. Then, advertisement information of a genre specified by the extracted advertisement genre information is read out from the advertisement information database (DB) 14, with which advertisement information of each genre is registered for each genre. Printing data are, then, generated by using the advertisement information read out, and the generated printing data are transmitted to the printer 3 along with a printing request for the advertisement and printed on media. Thus, advertising media are generated. Media to be printed on are, for example, pocket-seized packs of tissue papers, pieces of paper to be inserted into pocked-sized packs of tissue papers, and the like. The advertising medium generation part 12 can transmit instructions for enclosing advertising media to the printer 3, depending on a type of advertising media.

In the transmission processing part 13, processing for transmitting advertising media generated in the advertising medium generation part 12 to users. In particular, destination information (at least data on a name and address) specifying a destination of an advertisement is extracted from user information extracted in the advertising medium generation part 12 and then printing data are generated. The generated printing data are transmitted to the printer 3 along with a printing request for the destination and printed on envelopes or destination labels.

The storage part 22 consists of ROMs, hard discs, and the like, and stores various types of data necessary to an operating program and processing to be executed by the control part 21. In addition, the storage part 22 includes the user DB 13 and advertisement DB 14. In the user information DB 13, user information as exemplified in FIG. 3 is stored. In the advertisement DB 14, advertisement information is stored for each genre in association with a genre name and genre ID. The advertisement information is generated, for example, according to an advertiser's request, and registered with the advertisement DB 14. A data format of advertisement information is arbitrary and can include, for example, image data, text data, and the like.

The input part 23 consists of input devices such as a keyboard and a pointing device, and transmits input data to the control part 21. The display part 24 consists of an LCD (Liquid Crystal Display) or the like, and outputs various types of images, following the instructions of the control part 21. The communication control part 25 controls communication with other devices through a network, following the instructions of the control part 21.

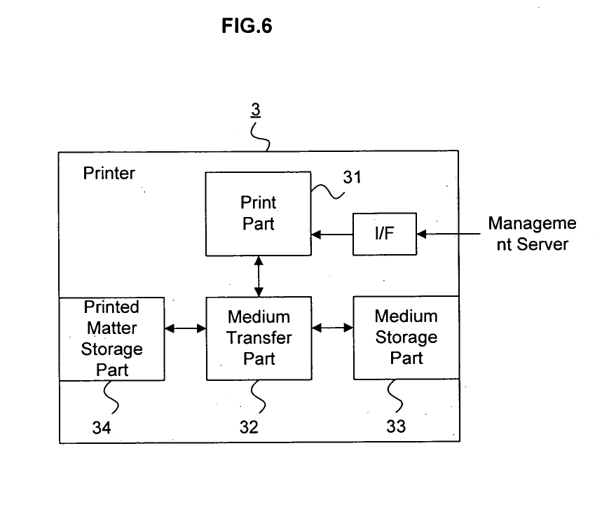

The printer 3 is, for example as shown in FIG. 6, equipped with a print part 31, a medium transfer part 32, a medium storage part 33 and a printed matter storage part 34, and connected to the management server 1. The print part 31 includes CPU, ROM, RAM and the like. In response to a printing request from the management server 1, the print part 31 notifies the medium transfer part 32 of a type of printing media specified by the request, prints printing data received on the printing media transferred by the medium transfer part 32, and supplies the printed media to the medium transfer part 32. In particular, the print part 31 notifies “for advertisement” as a type of printing media when received a printing request for advertisement and “for destination” as a type of printing media when received a printing request for destination. The medium transfer part 32, on receipt of the notification of a type of printing media, retrieves a medium corresponding to the type and transfers it to the print part 31. When the medium transfer part 32 receives each medium printed with printing data such as advertisement and destination, then it ejects the printed medium to the printed matter storage part 34 for each type of media. In the medium storage part 33, printing media (such as envelopes and destination labels) for destination, printing media (such as pocket-sized packs of tissue papers) for advertisement, and the like are stored for each type of media. In the printed matter storage part 34, media printed with advertisement, media printed with destination, and the like are stored for each type of media. Furthermore, when the print part 31 receives an instruction for enclosing advertising media along with a printing request, it notifies the advertisement transfer part 32 of the instruction. In the advertisement transfer part 32, media printed with advertisement corresponding to the enclosure instructions can be held in a prescribed area, the advertising media being held can then be enclosed in envelopes and sealed when received the envelopes printed with destinations, and finally they can be ejected to the printed matter storage part 34.

The user terminal 5 is for general consumer to register information with the management server 1 in order to receive an advertisement distribution, and includes a portable terminal such as a PDA or cell-phone or a personal computer. The user terminal 5 consists of a computer equipped with a control part, storage part, display part, input part and communication control part. The control part consists of CPU and the like. By reading out and executing an operation program or the like preliminarily stored in the storage part, the control part connects to the management server 1 through the network 10, receives input screen data of prescribed information, by which a user receives an advertisement distribution, and displays the screen on the display part. The control part, then, receives a data input for the input screen and transmits the input data to the management server 1. The storage part consists of ROMs, hard discs, and the like, and stores various types of data necessary to an operation program and processing to be executed by the control part. The display part consists of, for example, an LCD or the like, and outputs various types of screens, following the instructions of the control part. The input part consists of input devices such as a keyboard and a pointing device, and transmits input data to the control part. The communication control part controls communication with other devices through the network 10, following the instructions of the control part.

An operation of the distribution advertisement management system according to the embodiment of the present invention will then be described below.

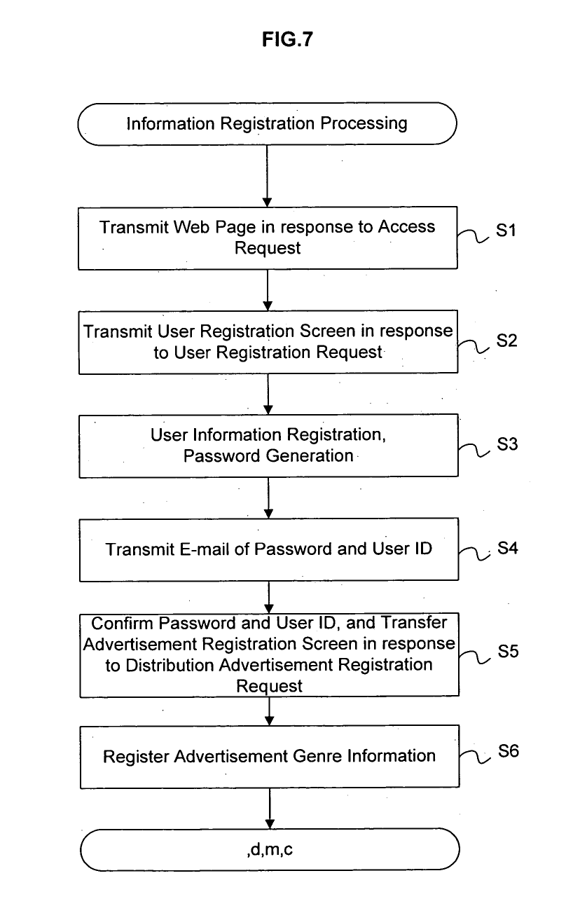

Firstly, information registration processing that user information and advertisement information are registered with the user information DB 13 in response to an access from the user terminal 5 will be described below in reference to FIG. 7.

Suppose, for example, a user A receives an advertising medium such as a pocket-sized pack of tissue papers, in which a website address provided by the management server 1 is described. The user A inputs the address described in the advertising medium into the user terminal 5 to receive an advertisement distribution. In response to this, the user terminal 5 transmits an access request to the management server 1, which is a computer specified by the input address. The control part 21 of the management server 1 responds to a reception of the access request and transmits a prescribed Web page (homepage) to the user terminal 5 (step S1). In the user terminal 5, a reception screen is displayed, and, for example, the user A clicks on “User Registration” on the screen. The user terminal 5 notifies the management server 1 that “User Registration” has been clicked on. In response to this, the management server 1 transmits data of a user registration screen, on which information such as a user ID, user name, address, mail address and fax number can be received, to the user terminal 5 (step S2). In the user terminal 5, the user registration screen received is displayed and data input for the screen are transmitted to the management server 1.

The control part 21 of the management server 1 registers the received data with the user DB 13 as user information and issues a password (step S3). The control part, then, transmits the user ID and the issued password to the mail address included in the user information while registering the issued password as a part of the user information (step S4). The user A who received the mail accesses the Web page using the user terminal 5 and clicks on “Distribution Advertisement Registration” on the Web page. The user terminal 5 notifies the management server 1 that “Distribution Advertisement Registration” has been clicked.

In response to this, the control part 21 of the management server 1 transmits an advertisement registration screen, on which an advertisement genre and distribution date a user desires can be input, to the user terminal 5 after receiving an input of the user ID and password and confirming that they have been registered with the user information DB 13 (step S5). In the user terminal 5, the advertisement registration screen received is displayed and an input for the screen is received. For example, if the user A desires to receive an advertisement on restaurants, the user A checks a checkbox for the genre name “Restaurants” on the screen. Also, if the user A desires to receive an advertisement on the first day of every month, the user A checks checkboxes for the desired distribution date “First Day” and for the distribution frequency “Monthly”. The user terminal 5 transmits the input data for the advertisement registration screen to the management server 1.

The control part 21 of the management server 1 generates advertisement genre information based on the received data and stores it with the user information DB 13 (step S6). Thus, the user information and the advertisement genre information for the user A are registered.

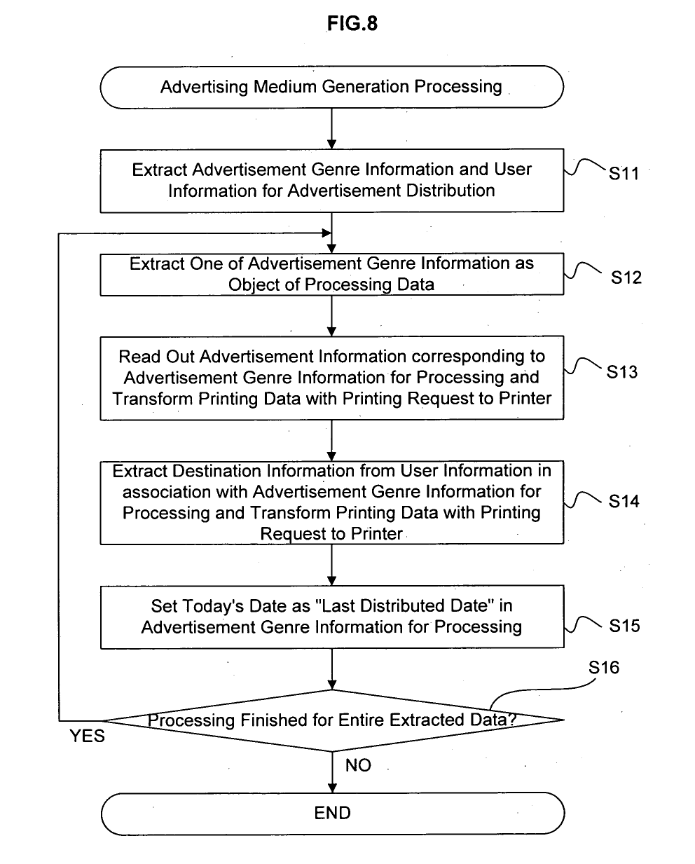

Secondly, advertising medium generation processing that generation or the like of advertising media is carried out based on information registered with the user information DB 13 will be described below in reference to FIG. 8.

The control part 21 of the management server 1 firstly extracts advertisement genre information for an advertisement distribution and the corresponding user information from the user information DB 13 (step S11). In particular, the control part 21 searches each of advertisement genre information registered with the user information DB 13 for the genre information, of which desired distribution date corresponds to today's date acquired from an internal clock and distribution frequency is set to be “Monthly”, and for the genre information, of which desired distribution date corresponds to today's date, distribution frequency is set to be “Bimonthly” and the last distributed date is set to be two-month-old date, and extracts the corresponding advertisement genre information and the relevant user information to it. The control part 21, then, extracts one of advertisement genre information as data for processing from the extracted advertisement genre information (step S12), reads out advertisement information corresponding to the genre specified by the advertisement genre information extracted from the advertisement information DB 14 and transmits printing data for it to the printer 3 along with a printing request for the advertisement (step S13). In response to this, the printer 3 prints the received advertisement information on printing media for advertisement (such as pocket-sized packs of tissue papers) and thus advertising media are generated. The control part 21 further extracts destination information from user information associated with the advertisement genre information, which is data for processing, and transmits the printing data for it along with a printing request for the destination to the printer 3 (step S14). In addition, the control part 21 set data on today's date as “Last Distributed Date” in advertisement genre information for processing (step S15). On the other hand, the printer 3 prints the received destination information on printing media for destinations (such as envelopes) in response to a printing request for the destination from the management server 1. Further, in case that the control part 21 transmits enclosure instructions along with the printing request, the printer 3 transfers the advertising medium printed according to the printing request of the step S2 to the top of the envelope printed according to the printing request of the step S3, encloses and seals it, and ejects the envelope enclosing the advertising medium. The control part, then, determines if entire processing for the advertisement genre information and user information extracted in the step S11 has been completed (step S16), and if not completed (step S16: NO), the above-mentioned processing for the next advertisement genre information and user information is carried out, back in the step 12. If processing for the entire advertisement information and user information is completed (step 16: YES), the processing is finished.

Thus, processing for transmitting an advertising medium printed with advertisement information on a genre a user desires to the user, including printing of destination information and the like, is carried out while generating the advertising medium. With the processing, an advertising medium printed with an advertisement a user desires can be sent to the user. In addition, envelopes stamped in advance (or bulk mail can be used) can be stored in the medium storage part 33 and a part of the printed matter storage part 34 can be employed as a mailbox. Furthermore, processing from a reception of a user's request for an advertisement distribution to a transmission of an advertising medium can be carried out by the present system when the printer 3 ejects an envelope, enclosing an advertising medium and sealed, to the mailbox, which is the printed matter storage part 34.

As described above, according to the present invention, appropriate advertisement information can be distributed to the appropriate general consumer, and also for an advertiser's side, a cost such as a labor cost for each provision of information can be reduced while trying to improve a communicative function. Furthermore, a bi-directional access to advertisement information becomes possible, and therefore the general consumer can easily select necessary information and therefore an advertisement function can be drastically improved. Also, since an advertisement of such as sex industry or usury, which does not want to be seen by others and easily disgusts, is very often inserted in advertising media such as pocket-sized packs of tissue papers being conventionally distributed without charge, it has been difficult to pick it up even if it were attractive or to take it back home. According to the present invention, however, since a user can specify an advertisement genre, the user can obtain and carry an advertising medium at ease.

In addition, media to be printed with an advertisement are not limited to pocket-sized packs of tissue papers and can include, for example, wet-tissues, sebum removing papers, pens, T-shirts, coupons, leaflets, samples, notepads, and the like. Further, papers and objects having a description of information such as a past record of lotteries and a baseball schedule can be used as the media.

Furthermore, various modifications and applications are applicable to the embodiment of the present invention.

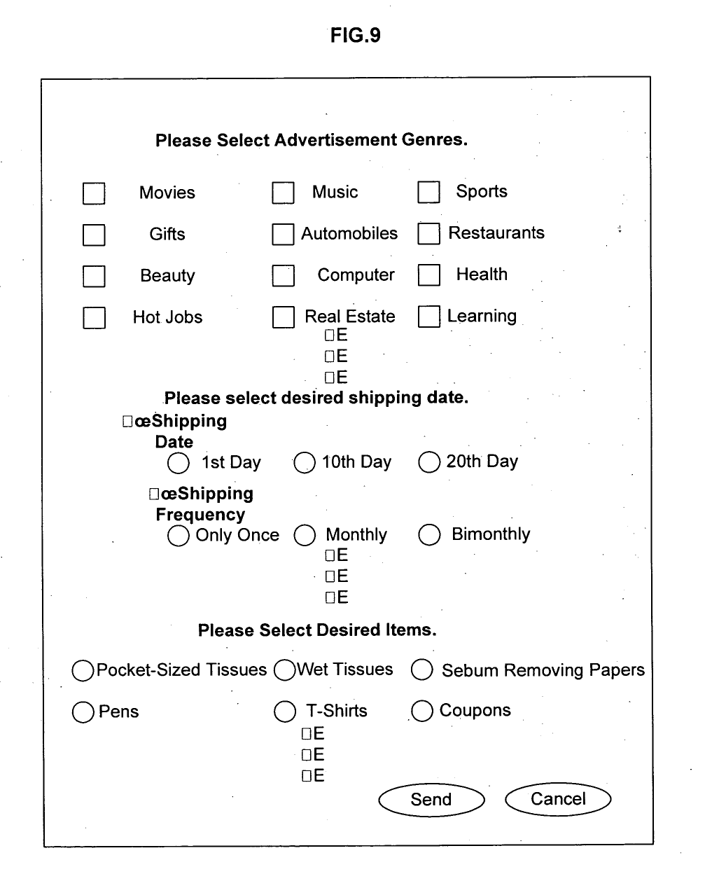

For example, several kinds of items of advertising media are prepared from which a user may further select one the user desires to have. In this case, the information registration part 11 transmits data of an advertisement registration screen, on which an input for the supply item the user desires to have can be received, to the user terminal 5. The selectable supply items can be, for example, pocket-sized packs of tissue papers, wet-tissues, sebum removing papers, pens, T-shirts, coupons, papers and objects having a description of information such as a past record of lotteries and a baseball schedule, and the like. When received input data for such an advertisement registration screen (see FIG. 9) from the user terminal, advertisement genre information based on the received data is generated and registered with the user information DB 13. The advertisement genre information in this case includes data of, for example, a user ID, advertisement genre, desired distribution date, the last distributed date, type of supply items, and the like. The advertising medium generation part 12, then, transmits a type of supply items along with the generated printing data and a printing request for the advertisement, regarding the advertisement genre information to be an object of advertising media generation processing, to the printer 3 for each type of the supply items. In the medium storage part 33 of the printer 3, the supply items are stored for each type of the supply items. The print part 31 notifies the medium transfer part 32 of a type of printing media “for advertisement” and a type of the supply items in response to the printing request from the management server 1, and the medium transfer part 32 retrieves a supply item corresponding to the notified type of the supply items from the medium storage part 33 and transfers it to the print part 31. Thus, an advertising medium, which is an item a user desires printed with an advertisement the user desires, can be generated and distributed to the user.

Items to supply to users can be charged or free. For example, for a user who desires to have high-quality items even if they are charged, the user's credit card number is registered and the items can be supplied with charge. In this case, for example, the advertisement registration screen can be adapted to display plurality of selectable supply items as shown in FIG. 9, and further display if each item is charged or free and prices or the like if charged. When the user selects a charged supply item, an input screen for a credit card number can be transmitted to the user terminal 5 and data of the user's credit card number input for the screen can be registered with the user information DB 13 as a part of the user information. Further, in advertising medium generation processing, when an advertising medium for charged item is generated, the user's credit card number can be extracted from the user information, and settlement request data including the credit card number, price of the supply item, information specifying a payee (payee's account number), and the like can be transmitted to a computer, with which the credit card settlement is carried out. Thus, the range of supply items can be increased. Further, if an advertiser desires to describe an advertisement in charged items when the advertiser registers advertisement information with the present system, the advertiser can indicate accordingly. According to the indication, a pay flag is given to the advertisement information on charged items among a lot of advertisement information to be registered with the advertisement DB 14. The advertising medium generation part 12 of the management server 1 selects advertisement information, which is specified by advertisement genre information for processing and also given a pay flag, when a user selects a charged supply item. On the other hand, when a user selects a free supply item, the advertising medium generation part 12 selects advertisement information, which is specified by advertisement genre information for processing and also not given a pay flag.

An advertisement, which corresponds to a genre selected by a user and also to an area the user lives in, can be distributed. In this case, advertising area information specifying an advertising area is further added to advertisement information registered with the advertisement DB 14. The storage part 22 further stores address/area information corresponding to an address and an advertising area. An advertiser can specify the advertising area. The advertising medium generation part 12 of the management server 1 extracts an address from user information associated with advertisement genre information for advertising medium generation, and reads out an advertising area corresponding to the address from address/area information in the storage part 22. Advertisement information, which corresponds to a genre specified by the advertisement genre information for processing and also to an advertising area corresponding to the address in the user information for processing, is read out from the advertisement DB 14, and printing data is generated. Thus, user's regional characteristics can be reflected in inserted advertisements.

In addition, the above-described advertising area information and a pay flag can be used together. With regard to an advertisement to be provided to a user, in this case, on the basis that the genre and supply item specified by the user are charged or free and also on the basis of the user's inhabited area, the relevant advertisement information is extracted from the advertisement DB 14. Thus, since a three-step filter comprised of a genre desired by a user, a price of supply item such as charged or free and the user's inhabited area is employed for extracting an advertisement, a target for the advertisement can be effectively focused.

If a user desired to stop an advertisement distribution service or change the user's registered information, the user can access a homepage provided by the management server 1 and select “Service Stop” or “Registered Information Change” on the homepage. The management server 1 can delete registered data associated with the input user ID when the service is stopped, or receive an input of information to change and update data registered with databases by the input data when registered information is changed, after receiving an input of the user ID and password and confirming them.

Advertisement information can also be provided to a user by fax or mail. In this case, the control part 21 of the management server 1 extracts user information including advertisement genre information corresponding to a specified genre from the user information DB 13, and destination information is extracted from the extracted user information and stored once in the storage part 22 when received the specification of the advertisement genre for processing. In case that an advertisement is provided by mail, for example, only the data on a mail address can be extracted. On the other hand, in case that an advertisement is provided by fax, for example, only the data on a fax number can be extracted. The control part 21, then, extracts user information for an advertisement distribution from the user information DB 13, based on distribution date information of the user information. In case that an advertisement is provided by mail, a mail address is extracted from the extracted user information and an e-mail attached with advertisement information specified by advertisement genre information in the user information is transmitted to the mail address. On the other hand, in case that an advertisement is provided by fax, a fax number is extracted from the extracted user information and fax data on advertisement information specified by advertisement genre information in the user information is faxed at the extracted fax number.

In addition, an output size of advertisement information is freely settable. A size of advertisement information to be output can be changed, depending on a size of a pocket-sized pack of tissue papers to be provided to a user.

Furthermore, users' comments on supply items can be posted on a homepage and the posted comments can be browsed. The management server 1 can stores and accumulates input comments on supply items in the storage part 22 and a Web page for browsing the comments can be set up for displaying the accumulated comments. The management server 1 can further be adapted to divide an evaluation for supply items into five stages or so, vote for one of the evaluation stages on a Web page for voting, store voting data input by each user in the storage part 22, count the number of votes for each supply item, and set up a Web page for displaying the vote result as popular goods ranking. In addition, manufacturers, materials, introduction of producers, sales areas, sales offices, prices, and the like for supply items can be placed on a Web page.

The management server 1 can also read in advertisement information such as announcements of local governments, announcements such as call for election and portraits of missing persons from the storage part 22, other computers or other storage media, generate advertising media printed with the advertisement read in and process for distributing the media to each user being registered with user information DB 13. Thus, a contribution to a society and community becomes possible.

A distribution method for advertising media such as pocket-sized packs of tissue papers, in which a website address provided by the management server 1 is described, is arbitrary, and therefore distributors can distribute on a street and users can pick an advertising medium up from baskets with the media placed in stores.

As recording media to store programs and data for realizing functions of a sales activity management of the present invention, in particular, CD-ROMs (-Rs/-RWs), magneto-optic discs, DVD-ROMs, FDs, flash memories, memory cards, memory sticks, other various types of ROMs and RAMs, and the like can be used. A management server and the like, which execute the above described processing, can be comprised by distributing the recording media and installing the program and the like into computers. Furthermore, the program and the like can be stored in disk drives of a server on a network such as Internet and downloaded into computers, for example, by superimposing on carrier.

What is claimed is:

1. A distribution advertisement management system comprising:
a user information registration part, in which an input of user information is received and registered with a user information database in response to an access request specifying an address described in an advertising medium;
an advertisement genre registration part, in which an input of an advertisement genre a user desires is received and registered with said user information database, relating advertisement genre information specifying the genre to said user information;
an extraction part, in which advertisement genre information and user information for an advertisement distribution are extracted from said user information database;
an advertisement extraction part, in which advertisement information on a genre specified by said extracted advertisement genre information is extracted from an advertisement database;
an advertising medium generation part, in which an advertising medium is generated by printing said extracted advertisement information on a medium; and
a transmission processing part, in which processing for transmitting said generated advertising medium to a destination of an advertisement specified by said extracted user information is carried out.

2. The distribution advertisement management system according to claim 1, wherein said advertising medium includes a pocket-sized pack of tissue papers.

3. The distribution advertisement management system according to claim 1, wherein said advertisement genre registration part displays plurality of items capable of supplying as an advertising medium and makes a user select the user's desired item from the plurality of items, and
said registration part registers supply item information specifying an item selected by a user with said user information database in association with said user information.

4. A distribution advertisement management method comprising the steps of:
receiving an input of user information and registering it with a user information database in response to an access request specifying an address described in an advertising medium;
receiving an input of an advertisement genre a user desires and registering advertisement genre information specifying the genre with said user information database in association with said user information;
extracting advertisement genre information and user information for an advertisement distribution from said user information database;
extracting advertisement information on a genre specified by said extracted advertisement genre information from an advertisement database;
generating an advertising medium by printing said extracted advertisement information on a medium; and
transmitting said generated advertising medium to a destination of an advertisement specified by said extracted user information.

5. A computer-readable recording medium, which stores a program with which a computer executes the steps of:
receiving an input of user information and registering it with a user information database in response to an access request specifying an address described in an advertising medium;
receiving an input of an advertisement genre a user desires and registering advertisement genre information specifying the genre with said user information database in association with said user information;
extracting advertisement genre information and user information for an advertisement distribution from said user information database;
extracting advertisement information on a genre specified by said extracted advertisement genre information from an advertisement database;
generating an advertising medium by printing said extracted advertisement information on a medium; and
transmitting said generated advertising medium to a destination of an advertisement specified by said extracted user information.

6. A computer data signal embedded in a carrier, which represents a program with which a computer executes the steps of:
receiving an input of user information and registering it with a user information database in response to an access request specifying an address described in an advertising medium;
receiving an input of an advertisement genre a user desires and registering advertisement genre information specifying the genre with said user information database in association with said user information;
extracting advertisement genre information and user information for an advertisement distribution from said user information database;
extracting advertisement information on a genre specified by said extracted advertisement genre information from an advertisement database;
generating an advertising medium by printing said extracted advertisement information on a medium; and
transmitting said generated advertising medium to a destination of an advertisement specified by said extracted user information.
